(19) United States
(12) Patent Application Publication
(10) Pub. No.: US 2009/0250244 A1
(43) Pub. Date: Oct. 8, 2009

(54) TRANSPARENT CONDUCTIVE FILM, DISPLAY DEVICE, AND MANUFACTURING METHOD THEREOF

(75) Inventors: Kumi TSUDA, Kumamoto (JP); Toshio Araki, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/419,610

(22) Filed: Apr. 7, 2009

(30) Foreign Application Priority Data
Apr. 8, 2008 (JP) 2008-100133

(51) Int. Cl. H01B 5/00; B44C 1/22

(52) U.S. Cl. 174/126.2; 216/13

(57) ABSTRACT

A transparent conductive film having a multilayer film of two or more layers (a pixel electrode, a gate terminal pad, and a source terminal pad) includes a first transparent conductive film having an amorphous structure, and a second transparent conductive film, formed over the first transparent conductive film, and having a crystalline structure.

### BACKGROUND OF THE INVENTION

1. Field of the Invention

The present invention relates to a transparent conductive film, a display device, and a manufacturing method thereof.

2. Description of Related Art

In general, liquid crystal display devices are built in such a manner that a pair of upper and lower electrode substrates, having each a transparent electrode formed thereon, is bonded by way of a sealing material applied to the periphery of an image display area on the substrates, with liquid crystal being filled in the space created by the sealing material and the two substrates. Liquid crystal display devices are classified into active matrix types and passive matrix types. Active matrix-type liquid crystal display devices comprise a TFT array substrate having thin film transistors, as switching elements, arranged forming a matrix. The TFT array substrate is bonded to a counter substrate, with the sealing material in between. Liquid crystal is filled then between the TFT array substrate and the counter substrate.

Scanning signal lines, display signal lines and pixel electrodes are formed in a display area of the TFT array substrate. The TFTs, as switching elements, are turned on/off in accordance with a scanning signal transmitted on the scanning signal lines. A display signal, transmitted on the display signal lines, is applied to a pixel electrode via a TFT. When the display signal is applied to the pixel electrode, a display voltage corresponding to the display signal is applied between a counter electrode and the pixel electrode, to drive thereby the liquid crystal.

The pixel electrode is formed in each pixel in such a manner so as to be connected to the drain electrode of the TFT via a contact hole provided in an insulating film lying below the pixel electrode. In the case of a transmissive pixel electrode used in, for instance, transmissive type liquid crystal display devices, the pixel electrode is formed by a transparent conductive film of ITO (indium tin oxide) or the like.

In a frame area, outside the display area, terminal portions are provided for the scanning signal lines and the display signal lines to be connected to a driver IC for liquid crystal driving. At the terminal portion, a terminal pad formed of the same transparent conductive film as that of the pixel electrode, is connected to a terminal extending from the scanning signal line or the display signal line, via a contact hole provided in the insulating film that lies below the terminal portion. Providing the terminal pad allows stabilizing the probing characteristics of the terminal portion while preventing terminal corrosion.

A transparent conductive film, connected via contact holes to a metallic film underneath, is formed thus at locations such as the pixel electrode and the terminal pad of the liquid crystal display device. Polycrystalline ITO films are widely used as the transparent conductive film (Japanese Unexamined Patent Application No. 10-268353). A strong acid such as aqua regia, comprising a system of hydrochloric acid+nitric acid, must be used for wet etching in the patterning process of polycrystalline ITO films. When thin films of low-resistance metals susceptible to attack by aqua regia, such as Mo (molybdenum) or Al (aluminum), is also present as scanning signal lines, display signal lines, drain electrode and so forth during wet etching of the ITO films, there is a risk that these metallic thin films suffer corrosion disconnection at the same time that the ITO film is etched.

By contrast, ITO films in an amorphous state can be wet-etched using a weak acid such as oxalic acid. Japanese Unexamined Patent Application No. 2005-259371 discloses a process that involves forming an ITO film in an amorphous state, and patterning then the ITO film using an etching solution of a weak acid such as oxalic acid, followed by crystallization and final chemical stabilization by heating or the like. This method allows patterning an ITO film without incurring corrosion disconnection in low-resistance metallic thin films of Mo or Al, when these are present. However, forming an ITO film in an amorphous state requires sputtering with using H₂O, which gives rise to numerous pinholes and defects in the resulting film. Moreover, partial micro-crystallization occurs in the vicinity the film interface during early film formation, which is likely to give rise to etching residues. The transition from an amorphous state to a crystalline state in an ITO film is accompanied by a contraction in volume, and hence step disconnection defects become more likely to occur, in particular at step portions. As a result, the terminal pad comprising the ITO film fails to protect sufficiently the metallic film at the terminal portion. This can lead to terminal corrosion, which is problematic from the viewpoint of reliability.

Japanese Unexamined Patent Application No. 2005-259371, therefore, discloses a method of forming a transparent conductive film by layering two or more ITO films. In this method, a lower ITO film is formed in an amorphous state, and then a resist pattern is formed thereon by way of a photolithography process. With the resist pattern as a mask, the ITO film is etched using a solution containing oxalic acid. After removing the resist pattern, the ITO film is subjected to a thermal treatment to elicit poly-crystallization in the amorphous ITO film. A polycrystalline lower ITO film is formed as a result. However, the contraction in volume that accompanies the above-described crystallization gives rise to step disconnection defects, in particular at step portions.

An upper ITO film is formed next, in an amorphous state, from the top of the lower ITO film. The upper ITO film is poly-crystallized epitaxially at portions over the lower ITO film, while at other portions the upper ITO film is formed in an amorphous state. The upper ITO film in an amorphous state is removed as-is, by etching, using a solution containing oxalic acid, without the need for a photolithography process for forming a resist pattern. The polycrystalline upper ITO film is patterned thereby in such a manner so as to cover the step disconnections of the lower ITO film. The obtained transparent conductive film comprises a stack of two polycrystalline ITO films. By forming thus a transparent conductive film comprising a stack of two or more polycrystalline ITO films, this method allows preventing the occurrence of step disconnection defects in step portions.

However, forming a transparent conductive film comprising a stack of two or more polycrystalline ITO films in accordance with the above method involves the following problems. Partial micro-crystallization takes place in the vicinity of the film interface during early formation of the lower ITO film. This is likely to result in etching residues, since the crystallized portions cannot be etched using a solution containing oxalic acid. No matter how slight, any etching residues in the lower ITO film induce micro-crystal growth in the upper ITO film that forms over the etching residues. As a result, such portions fail to be removed by etching, and give rise to etching defects. Also, the upper ITO film is patterned in such a manner that it protrudes, eave-like, beyond the lower ITO film, causing thereby the transparent conductive film to overhang.

With a view to solving the above problems, it is an object of the present invention to provide a transparent conductive film, a display device and a manufacturing method thereof, that allow easily obtaining a desired pattern, with high reliability and excellent coverage.

### SUMMARY OF THE INVENTION

According to an aspect of an embodiment of the present invention, there is provided a transparent conductive film having a multilayer film of two or more layers (which corresponds to a pixel electrode 18, a gate terminal pad 19, and a source terminal pad 19 according to an embodiment of the present invention), that includes a first transparent conductive film (which corresponds to a pixel electrode 18a, a gate terminal pad 19a, and a source terminal pad 19a according to an embodiment of the present invention) having an amorphous structure, and a second transparent conductive film (which corresponds to a pixel electrode 18b, a gate terminal pad 19b, and a source terminal pad 19b according to an embodiment of the present invention), formed over the first transparent conductive film, and having a crystalline structure.

According to another aspect of an embodiment of the present invention, there is provided a method of manufacturing a transparent conductive film having a multilayer film of two or more layers, that comprises the steps of forming a first transparent conductive film of stable amorphous structure over a substrate in an amorphous state, forming a second transparent conductive film of stable crystalline structure over the first transparent conductive film in an amorphous state, etching the first transparent conductive film and the second transparent conductive film, and crystallizing the second transparent conductive film after the etching step.

The present invention is able to provide a transparent conductive film, a display device and a manufacturing method thereof, that allow easily obtaining a desired pattern, with high reliability and excellent coverage.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a front view illustrating the structure of a TFT array substrate used in a display device;

FIG. 2 is a plan view of a TFT array substrate according to a first embodiment; and

FIG. 3 is a cross-sectional view along line III-III of FIG. 2.

### DESCRIPTION OF THE PREFERRED EMBODIMENTS

Preferred embodiments of the present invention are explained below. The explanation below relates to embodiments of the present invention. However, the invention is in no way meant to be limited to these embodiments. For the sake of a simpler explanation, suitable omissions and simplifications may be made to the disclosure and accompanying figures below. To make the explanation clearer, moreover, recurrent explanations will be omitted as the case may require. In the figures, identical reference numerals denote identical elements, the explanation whereof may be suitably omitted.

### First Embodiment

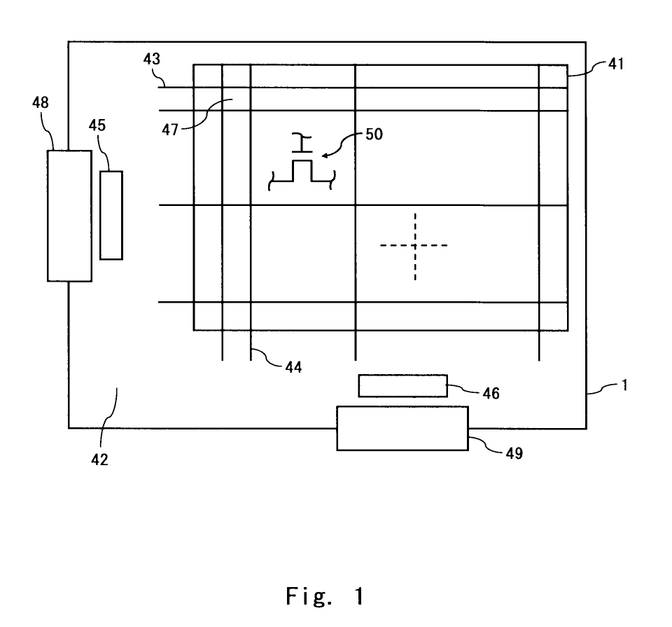

A display device using a transparent conductive film according to an embodiment of the present invention will be explained first with reference to FIG. 1. FIG. 1 is a front view illustrating the structure of a TFT array substrate used in a display device. The display device according to the present embodiment will be explained on the basis of an example of a transmissive type liquid crystal display device. This example, however, is merely illustrative in nature, and the display device of the present embodiment may also be used in, for instance, a transflective type liquid crystal display device. The first embodiment and other embodiments described below share the same overall constitution of the liquid crystal display device.

The liquid crystal display device according to the embodiment of the present invention includes an insulating substrate 1. The substrate 1 may be an array substrate such as a TFT array substrate. The substrate 1 includes a display area 41 and a frame area 42 which surrounds the display area 41. In the display area 41, a plurality of gate lines (scanning signal lines) 43 and a plurality of source lines (display signal lines) 44 are placed. The plurality of gate lines 43 are arranged in parallel. Likewise, the plurality of source lines 44 are arranged in parallel. The gate lines 43 and the source lines 44 cross each other. The gate lines 43 and the source lines 44 are orthogonal to each other. The area which is surrounded by the adjacent gate lines 43 and the source lines 44 serves a pixel 47. Thus, the pixels 47 are arranged in matrix on the substrate 1.

In the frame area 42 of the substrate 1, a scanning signal driving circuit 45 and a display signal driving circuit 46 are placed. The gate line 43 extends from the display area 41 to the frame area 42. The gate line 43 is connected to the scanning signal driving circuit 45 at the end of the substrate 1. The source line 44 also extends from the display area 41 to the frame area 42. The source line 44 is connected to the display signal driving circuit 46 at the end of the substrate 1. An external line 48 is placed in the vicinity of the scanning signal driving circuit 45. An external line 49 is placed in the vicinity of the display signal driving circuit 46. The external lines 48 and 49 may be wiring boards such as a flexible printed circuit (FPC).

Various signals are supplied from the outside to the scanning signal driving circuit 45 and the display signal driving circuit 46 through the external lines 48 and 49, respectively. The scanning signal driving circuit 45 supplies a gate signal (scanning signal) to the gate line 43 according to a control signal from the outside. By the gate signal, the gate lines 43 are selected sequentially. The display signal driving circuit 46 supplies a display signal (source signal) to the source line 44 according to a control signal from the outside or display data. A display voltage corresponding to the display data is thereby supplied to each pixel 47. The scanning signal driving circuit 45 and the display signal driving circuit 46 are not necessarily placed on the substrate 1. For example, the driving circuits may be connected by using tape carrier package (TCP).

At least one thin film transistor (TFT) 50 is placed in the pixel 47. The TFT 50 is located in the vicinity of the intersection between the gate line 43 and the source line 44. For example, the TFT 50 supplies a display voltage to a pixel electrode. Specifically, the TFT 50, which is a switching element, is turned on by the gate signal from the gate line 43. A display voltage is thereby applied from the source line 44 to the pixel electrode which is connected to a drain electrode of the TFT 50. Then, an electric field corresponding to the display voltage is generated between the pixel electrode and a counter electrode. An alignment layer (not shown) is placed on the surface of the substrate 1.

A counter substrate is placed opposite to the substrate 1. The counter substrate may be a color filter substrate, for example, which is located at the viewing side. In the counter substrate, a color filter, a black matrix (BM), a counter electrode, an alignment layer and so on are placed. The counter electrode may be placed in the substrate 1 instead. A liquid crystal layer is placed between the substrate 1 and the counter substrate. In other words, liquid crystal is filled between the substrate 1 and the counter substrate. Further, a polarization plate, a retardation film and so on are placed on the outside surfaces of the substrate 1 and the counter substrate. Further, a backlight unit or the like is placed at the non-viewing side of the liquid crystal panel.

The liquid crystal is driven by the electric field between the pixel electrode and the counter electrode. The orientation of the liquid crystal between the substrates thereby changes. The polarization state of the light which passes through the liquid crystal layer changes accordingly. The light which passes through the polarization plate becomes linearly polarized light, and it further changes its polarization state by passing through the liquid crystal layer. Specifically, the light from the backlight unit becomes linearly polarized light by the polarization plate on the array substrate side. Then, the linearly polarized light passes through the liquid crystal layer, so that its polarization state changes.

Therefore, the amount of light which passes through the polarization plate on the counter substrate side varies depending on the polarization state. Specifically, the amount of the light which passes through the polarization plate at the viewing side, out of the transmitted light transmitting from the backlight unit to the liquid crystal display panel and the reflected light reflected at the liquid crystal display panel, varies. The orientation of the liquid crystal varies depending on a display voltage to be applied. It is therefore possible to change the amount of light which passes through the polarization plate at the viewing side by controlling the display voltage. A desired image can be displayed by varying the display voltage for each pixel.

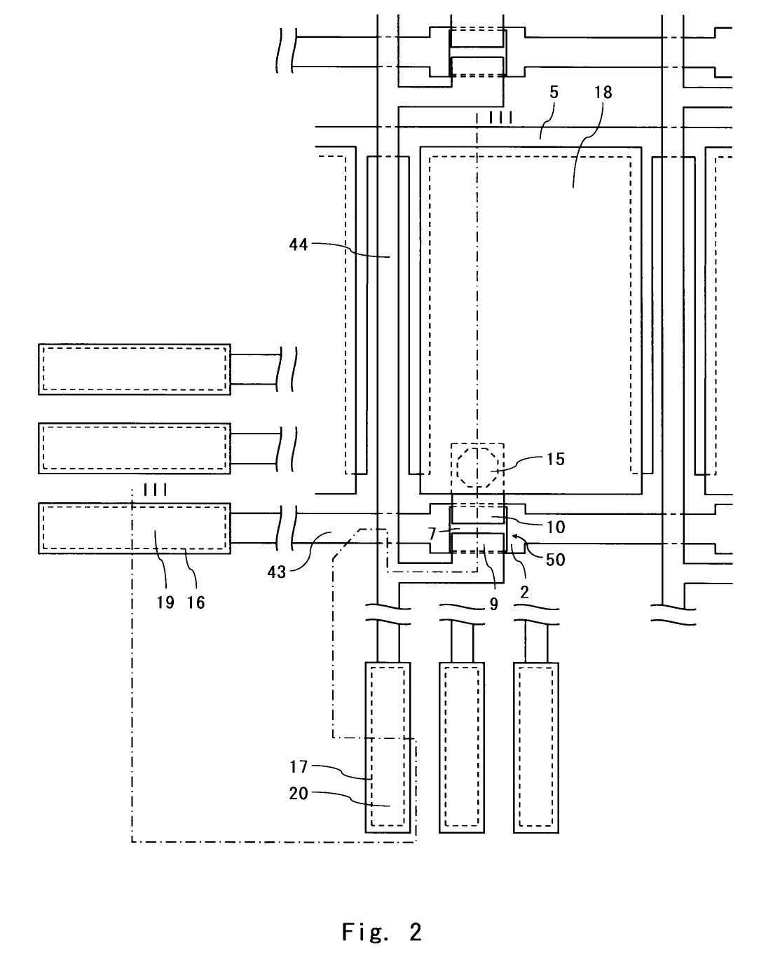

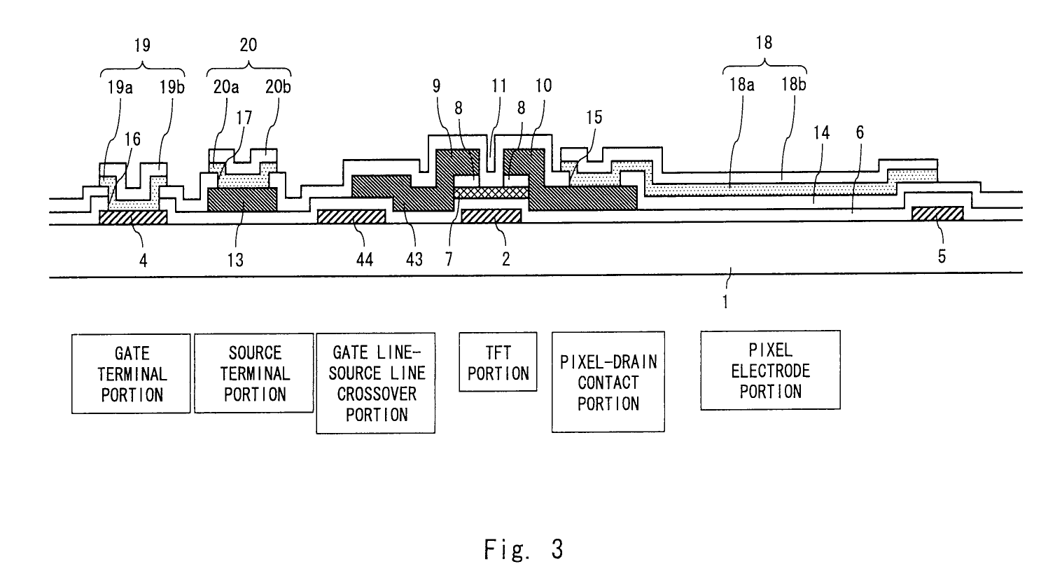

The constitution of a pixel in the TFT array substrate will be explained with reference to FIGS. 2 and 3. FIG. 2 is a plan view of a TFT array substrate according to the first embodiment. FIG. 3 is a cross-sectional view along line III-III of FIG. 2. FIG. 2 is a plan view showing one pixel 47 on the TFT array substrate. A plurality of such pixels 47 are arranged matrix-like on the TFT array substrate. FIGS. 2 and 3 depict the constitution of the pixel 47 as well as the constitutions of a gate terminal portion and a source terminal portion.

In FIGS. 2 and 3, a substrate 1 has formed thereon a gate electrode 2, a gate line 43, a gate terminal 4, and an auxiliary capacitive electrode 5. The substrate 1 is a transparent insulating substrate such as glass or plastic. The gate line 43 joins the gate electrode 2 at a display area 41. The gate line 43 joins the gate terminal 4 at the frame area 42. A video gate signal (scanning signal) is inputted from the gate terminal 4. The auxiliary capacitive electrode 5 is formed between adjacent gate lines 43. The auxiliary capacitive electrode 5, which is an electrode that makes up a capacitor for enabling stable display, sustains the driving voltage from the TFT 50 even after the latter, which is connected to a respective pixel 47, is turned off.

The gate electrode 2, the gate line 43, the gate terminal 4 and the auxiliary capacitive electrode 5 are formed of a metallic film or an alloy film having as a main component a metal of low-electrical specific resistance, such as Al, Mo or Cr.

A gate insulating film 6 is provided in such a way so as to cover the gate electrode 2, the gate line 43, the gate terminal 4 and the auxiliary capacitive electrode 5. The gate insulating film 6 is, for instance, silicon nitride (SiNx). A semiconductor film 7 is provided opposite the gate electrode 2, with the gate insulating film 6 interposed therebetween. The semiconductor film 7 is formed of, for instance, amorphous silicon (a-Si).

On the semiconductor film 7 there are formed a source electrode 9, a drain electrode 10, a source line 44 and a source terminal 13. The source electrode 9 and the drain electrode 10 are provided spaced apart and facing each other on the semiconductor film 7. A low ohmic resistance film 8 is formed between the source electrode 9 and the semiconductor film 7, and between the drain electrode 10 and the semiconductor film 7. The low ohmic resistance film 8 is provided at a region where the source electrode 9 overlaps the semiconductor film 7. Likewise, the low ohmic resistance film 8 is provided at a region where the drain electrode 10 overlaps the semiconductor film 7. The low ohmic resistance film 8 is heavily doped with impurities, and forms therefore an ohmic contact with the semiconductor film 7. For instance, the low ohmic resistance film 8 is formed of a Si film doped with impurities. The region within the semiconductor film 7 that is not covered by the source electrode 9 or the drain electrode 10 constitutes a channel portion 11 of the TFT 50.

The source electrode 9 joins the source line 44 at the display area 41. The source line 44 joins the source terminal 13 at the frame portion 42. A video source signal (display signal) is inputted to the source line 44 through the source terminal 13. The source electrode 9, the drain electrode 10, the source line 44 and the source terminal 13 are formed of a metallic film or an alloy film having as a main component a metal of low-electrical specific resistance, such as Al, Mo or Cr.

An interlayer insulating film 14 is formed in such a way so as to cover the source electrode 9, the drain electrode 10, the source line 44 and the source terminal 13. A contact hole 15 penetrating the interlayer insulating film 14 is provided over the drain electrode 10. A contact hole 16 penetrating the gate insulating film 6 and the interlayer insulating film 14 is opened over the gate terminal 4. A contact hole 17, at which the interlayer insulating film 14 is removed, is formed over the source terminal 13. The contact holes 15, 16, 17 form thus opening portions having steps in the interlayer insulating film 14. The interlayer insulating film 14 is formed of, for instance, silicon nitride (SiNx) film.

A pixel electrode 18 connected to the drain electrode 10 via the contact hole 15 is formed on the interlayer insulating film 14. A gate terminal pad 19 and a source terminal pad 20, comprising the same transparent conductive film as the pixel electrode 18, are formed at the frame area 42. The gate terminal pad 19 is provided in such a manner that it is connected to the gate terminal 4 via the contact hole 16. The source terminal pad 20 is disposed in such a manner that it is connected to the source terminal 13 via the contact hole 17.

In the present embodiment, the transparent conductive film that makes up the pixel electrode 18, the gate terminal pad 19 and the source terminal pad 20 is a multilayer film comprising a first transparent conductive film having an amorphous structure, and layered thereon, a second transparent conductive film having a crystalline structure. Here, an IZO film having a stable amorphous phase is formed as the first transparent conductive film, while a polycrystalline ITO film is formed as the second transparent conductive film, for example. Therefore, the pixel electrode 18 has a multilayer structure in which a pixel electrode 18b, comprising the second transparent conductive film having a crystalline structure, is layered on a pixel electrode 18a, that comprises the first transparent conductive film having an amorphous structure. The gate terminal pad 19 has a multilayer structure in which a gate terminal pad 19b, comprising the second transparent conductive film having a crystalline structure, is layered on a gate terminal pad 19a, that comprises the first transparent conductive film having an amorphous structure. The source terminal pad 20 has a multilayer structure in which a source terminal pad 20b, comprising the second transparent conductive film having a crystalline structure, is layered on a source terminal pad 20a, that comprises the first transparent conductive film having an amorphous structure.

A method for manufacturing the TFT array substrate of the present embodiment is explained next. Firstly, the substrate 1 comprising a transparent insulating substrate such as glass or the like is cleaned with a cleaning solution or with pure water. After cleaning, a first metal film is deposited on the substrate 1. As the first metal film there is preferably used a metallic film made of a metal having low-electrical specific resistance, such as Al, Mo or Cr, or an alloy film having any of these metals as a main component. The first metal film is deposited over the entire surface of the substrate 1 by sputtering or the like. A resist pattern is then formed on the first metal film by a first photolithography process. The first metal film is patterned by etching, after which the resist pattern is removed. The gate electrode 2, the gate line 43, the gate terminal 4 and the auxiliary capacitive electrode 5 are formed thereby.

The gate insulating film 6, the semiconductor film 7 and the low ohmic resistance film 8 are deposited next. Specifically, the gate insulating film 6 is formed in such a way so as to cover the gate electrode 2, the gate line 43, the gate terminal 4 and the auxiliary capacitive electrode 5. The semiconductor film 7 and the low ohmic resistance film 8 are sequentially layered on the gate insulating film 6. For instance, the gate insulating film 6, the semiconductor film 7 and the low ohmic resistance film 8 are deposited, in this order, by chemical vapor deposition (CVD) For instance, a silicon nitride (SiNx) film is deposited over the entire surface of the substrate 1 to yield the gate insulating film 6. An amorphous silicon (a-Si) film is deposited over the entire surface of the substrate 1 to yield the semiconductor film 7. Further, n-type amorphous silicon (n+a-Si) doped with an impurity such as phosphorus (P) is deposited over the entire surface of the substrate 1 to yield the low ohmic resistance film 8.

Thereafter, a second photolithography process is carried out to form a resist pattern on the low ohmic resistance film 8. The low ohmic resistance film 8 and the semiconductor film 7 are patterned by etching. Etching is carried out, for instance, by dry etching using a known fluorine-based gas. Subsequent removal of the resist pattern yields the semiconductor film 7 and the low ohmic resistance film 8 that are formed opposite the gate electrode 2, with the gate insulating film 6 interposed therebetween.

A second metal film is deposited next in such a way so as to cover the semiconductor film 7 and the low ohmic resistance film 8. As the second metal film there is preferably used a metallic film made of a metal having low-electrical specific resistance, such as Al, Mo or Cr, or an alloy film having any of these metals as a main component. The second metal film is deposited over the entire surface of the substrate 1 by sputtering or the like. After formation of the second metal film, a third photolithography process is carried out to form a resist pattern. Etching is carried out then using the resist pattern as a mask, to pattern the second metal film. The source electrode 9, the drain electrode 10, the source line 44 and the source terminal 13 are formed thereby.

The low ohmic resistance film 8 exposed at the surface, and not covered by the source electrode 9 or the drain electrode 10, is removed then by etching. The semiconductor film 7 between the source electrode 9 and the drain electrode 10 is exposed, for instance, by dry etching or the like using a known fluorine-based gas. The resist pattern is then removed to form the channel portion 11. After removal of the exposed low ohmic resistance film 8, the surface may be subjected to a plasma treatment using hydrogen (H₂) gas, nitrogen (N₂) gas or oxygen (O₂) gas, or a mixed gas of a combination of the foregoing. Doing so allows improving the characteristics of the TFT, in particular off characteristics.

The interlayer insulating film 14 is deposited next. For instance, a silicon nitride (SiNx) film is deposited by CVD over the entire surface of the substrate 1. A fourth photolithography process is carried out then, to form a resist pattern on the interlayer insulating film 14. The interlayer insulating film 14 and the gate insulating film 6 are etched using this resist pattern as a mask. Etching is carried out, for instance, by dry etching using a known fluorine-based gas. Subsequent removal of the resist pattern yields simultaneously the contact hole 15 that reaches down to the drain electrode 10, the contact hole 16 that reaches down to the gate terminal 4, and the contact hole 17 that reaches down to the source terminal 13.

In the present embodiment, a first transparent conductive film that yields the pixel electrode 18a, the gate terminal pad 19a and the source terminal pad 20a is deposited then over the entire surface of the substrate 1. Here, a 50 nm-thick IZO film is formed as the first transparent conductive film, by DC magnetron sputtering using a mixed gas resulting from adding O₂ gas to Ar gas, for example. Sputtering is carried out here in using an IZO target which is a transparent conductive oxide comprising a mixture of indium oxide (In₂O₃) and zinc oxide (ZnO) at a weight ratio of 90:10, with the substrate temperature during film formation set to 100° C.

The second transparent conductive film, which yields the pixel electrode 18b, the gate terminal pad 19b and the source terminal pad 20b, is deposited over the entire surface of the substrate 1 subsequently after the deposition of the first transparent conductive film. Here, a 50 nm-thick ITO film is deposited as the second transparent conductive film, by DC magnetron sputtering using a mixed gas resulting from adding H₂O gas and O₂ gas to Ar gas, for example. Sputtering is carried out herein using an ITO target which is a transparent conductive oxide comprising a mixture of indium oxide (In₂O₃) and tin oxide (SnO₂) at a weight ratio of 90:10, with the substrate temperature during film formation set to 100° C.

The above-described consecutive film deposition yields for instance a 100 nm-thick transparent conductive film comprising a multilayer film in which a 50 nm-thick second transparent conductive film is layered on a 50 nm-thick first transparent conductive film. No crystal peaks are observed in X-ray diffraction patterns of the first transparent conductive film and the second transparent conductive film, which exhibit both an amorphous state. In the present embodiment, thus, a film such as an IZO film, whose chemically stable state is an amorphous phase, is used as the first transparent conductive film, and a film such as an ITO film, whose chemically stable state is a crystalline phase, is used as the second transparent conductive film. The first transparent conductive film and the second transparent conductive film thus are sequentially deposited in an amorphous state.

A fifth photolithography process is carried out next to form a resist pattern on the transparent conductive film comprising a multilayer film. Etching is carried out then using the resist pattern as a mask, to pattern thereby the transparent conductive film comprising a multilayer film. The first transparent conductive film and the second transparent conductive film are patterned simultaneously by etching. For instance, the IZO film as the first transparent conductive film and the ITO film as the second transparent conductive film are collectively wet etched using a known oxalic acid-based solution (TIO-05N, by Kanto Chemical Co., Inc.).

The amorphous phase of the IZO film formed as the first transparent conductive film is fundamentally in a chemically stable state. As a result, a substantially homogeneous amorphous phase can be obtained by ordinary sputtering. The IZO film can therefore be dissolved completely, leaving no etching residues, using an ordinary oxalic acid-based etching solution.

The crystalline phase (polycrystal) of the ITO film formed as the second transparent conductive film is fundamentally stable. To form an ITO film as an amorphous-phase film, therefore, sputtering must be carried out by mixing a gas such as H₂O or H₂ into the sputtering gas. Although the resulting X-ray diffraction pattern is that of an amorphous phase, with no observable crystal peaks, some partial fine crystal-grain growth, arising from an increase in substrate temperature during sputtering or resulting from process fluctuations, may occur on the lower side of the film. Such portions of fine crystal-grain growth cannot be dissolved using an oxalic acid-based etching solution.

In the present embodiment, however, a transparent conductive film is deposited in the form of a multilayer film in which the ITO film is layered on an IZO film. Therefore, the IZO film underneath the ITO film dissolves completely during etching using an oxalic acid-based solution, as a result of which the portions in the ITO film where fine crystal-grains have grown are removed by lift off. Thus, no etching residues are actually observed between patterns upon observation by electron microscopy (SEM) immediately after etching. It becomes possible therefore to prevent portions of ITO where fine crystal-grain has grew near the film interface during early film deposition from persisting in the form of etching residues.

After etching of the transparent conductive film comprising a multilayer film, the resist pattern is removed to form thereby the pixel electrode 18 that is connected to the drain electrode 10 via the contact hole 15. Simultaneously therewith there are formed the gate terminal pad 19 that is connected to the gate terminal 4 via the contact hole 16 and the source terminal pad 20 that is connected to the source terminal 13 via the contact hole 17. That is, the pixel electrode 18, the gate terminal pad 19 and the source terminal pad 20 are formed by a transparent conductive film comprising a two-layer multilayer film. Thereafter, the TFT array substrate is annealed in the atmosphere by being held for 30 minutes at 300° C. After annealing, the IZO film of the first transparent conductive film preserves its amorphous phase but the ITO film of the second transparent conductive film exhibits X-ray diffraction peaks that denote a polycrystalline phase. As is known, polycrystalline-phase ITO films boast excellent chemical resistance.

Annealing elicits thus a phase change from an amorphous phase to a polycrystalline phase in the ITO film of the second transparent conductive film. This phase change is accompanied by a contraction in volume that gives rise to stresses in the second transparent conductive film. The stresses generated in the second transparent conductive film, however, are relieved by providing the underlying first transparent conductive film, which undergoes no phase change. The occurrence of cracking and/or step disconnections in the second transparent conductive film can be reduced thereby. The first transparent conductive film undergoes no phase changes, and therefore exhibits no cracking or step disconnections. Even if cracking or step disconnection occurs in the second transparent conductive film, therefore, the first transparent conductive film acts as a barrier layer that prevents solution intrusion. The transparent conductive film of the present embodiment exhibits thus high resistance to corrosion by solutions of chemicals.

The transparent conductive film comprising a multilayer film after annealing has a specific resistance of 300 μΩcm and a transmittance of 90% at a wavelength of 550 nm, which are comparable to the values of an IZO-only film or an ITO-only film. The TFT array substrate of the present embodiment is completed as a result the above steps.

In the present embodiment, thus, a transparent conductive film comprising a multilayer film is formed by depositing, in an amorphous state, a second transparent conductive film having a chemically stable crystalline phase, on a first transparent conductive film having a chemically stable amorphous phase. After patterning of this transparent conductive film by etching using an oxalic acid-based solution, a phase change from an amorphous state to a crystalline state is induced in the second transparent conductive film by way of an annealing treatment. In such a method, the first transparent conductive undergoes no phase change in the annealing treatment. This allows reducing cracking and step disconnection defects that accompany phase changes in the second transparent conductive film. The first transparent conductive film acts as barrier, should any cracking and/or step disconnection defects occur. Layering the first transparent conductive film with the second transparent conductive film allows mutually compensating for pinholes and film defects that occur during sputtering. Moreover, the first transparent conductive film and the second transparent conductive film are etched simultaneously, which prevents overhang formation. Therefore, a desired pattern having high reliability and excellent coverage can be easily obtained, so that a highly reliable TFT array substrate can be obtained as a result.

Even if micro-crystallization occurs partially during formation of the second transparent conductive film, at the top layer, the first transparent conductive film can be removed by dissolution using an oxalic acid-based etching solution. This allows preventing formation of etching residue. The etching solution used is an oxalic acid-based etching solution, and hence the transparent conductive film comprising a multilayer film can be patterned even when low-resistance metallic films of Mo, Al or the like are also present, without inducing corrosion breaks in any of these metallic films. Low-resistance metallic films of Mo, Al or the like can therefore be used in the gate line 43, the source line 44, the drain electrode 10 and so forth, and thus resistance can be reduced.

### Other Embodiments

An example has been explained in which the pixel electrode 18, the gate terminal pad 19 and the source terminal pad 20 are formed by a transparent conductive film comprising a two-layer multilayer film in which a second transparent conductive film is layered on a first transparent conductive film. The invention, however, is not limited thereto. For instance, the transparent conductive film may be a transparent conductive film comprising a three-layer multilayer film in which the first transparent conductive film and the second transparent conductive film sandwich therebetween a metallic film having a specific resistance lower than that of the first and the second transparent conductive films.

In a preferred example of such a build-up, an IZO film is formed, as the first transparent conductive film, to a thickness of 50 nm, an Ag film is formed thereafter to a thickness of 5 nm, and then an amorphous ITO film, as the second transparent conductive film, is formed to a thickness of 50 nm, to yield thereby, through sequential film formation, a three-layer multilayer transparent conductive film. The Ag film can be deposited in the same way as the IZO film and the ITO film, for instance by sputtering or the like.

The fifth photolithography process is carried out next to form a resist pattern on the transparent conductive film. Etching is carried out then using the resist pattern as a mask, to pattern thereby the transparent conductive film comprising a multilayer film. For instance, the IZO film, the Ag film and the ITO film that make up the transparent conductive film are collectively etched by wet etching using a known oxalic acid-based solution (TIO-05N, by Kanto Chemical Co., Inc.). The interlayer Ag film is thin, having a thickness of 5 nm, and hence can be etched along with the IZO and ITO films, using an oxalic acid-based solution. A known phosphoric acid+nitric acid+acetic acid solution may also be used when the cross-sectional shape of the transparent conductive film exhibits irregularities in the form of protrusions and/or indentations, caused by a faster etching rate of the interlayer Ag film. The IZO film, the Ag film and the ITO film that make up the transparent conductive film can be collectively wet-etched using the phosphoric acid+nitric acid+acetic acid solution.

The resist pattern is removed after etching of the transparent conductive film comprising a multilayer film. The pixel electrode 18, the gate terminal pad 19 and the source terminal pad 20 are formed as a result by a transparent conductive film that comprises a three-layer multilayer film. Thereafter, the TFT array substrate is annealed by being held for 30 minutes in the atmosphere, at 300° C. After annealing, the IZO film of the first transparent conductive film preserves its amorphous phase but the ITO film of the second transparent conductive film exhibits X-ray diffraction peaks that denote a polycrystalline phase. The transparent conductive film comprising the multilayer film after annealing has a specific resistance of 100 μΩcm and a transmittance of 90% at a wavelength of 550 nm. The specific resistance can be reduced to about ⅓ by forming the Ag film between the IZO film and the ITO film. Since the specific resistance of the transparent conductive film can be thus reduced, the latter can be suitably used as a terminal pad in devices where lower resistance values in signal input terminal portions are required, for instance in COG (chip on glass) mounting.

The specific resistance of the transparent conductive film comprising a multilayer film can be adjusted by varying the thickness of the interlayer Ag film. For instance, the specific resistance of the transparent conductive film can be reduced from 100 μΩcm to about 50 μΩcm by increasing the thickness of the Ag film from 5 nm to 10 nm. It should be noted that, although the specific resistance of the transparent conductive film decreases as the thickness of the interlayer Ag film increases, this is accompanied by a drop in the value of optical transmittance. In a transmissive pixel electrode of a transmissive type liquid crystal display device, the transmittance value at the 550 nm wavelength is preferably not lower than 80%. Such being the case, the thickness of the interlayer Ag film is preferably no greater than 20 nm. A thickness of the interlayer Ag film below 5 nm precludes achieving a sufficient specific resistance lowering effect. Therefore, the thickness of the interlayer Ag film is preferably no smaller than 5 nm.

In the above explanation, an Ag film is formed as an interlayer, but the interlayer is not limited to an Ag film, and may be, for instance, a metal such as aluminum (Al), copper (Cu) or gold (Au) having a lower specific resistance than the first transparent conductive film and the second transparent conductive film, or an alloy film having any of these metals as a main component. Among these metals, Ag exhibits a particularly large specific resistance reducing effect, and hence Ag is suitably used as the interlayer. The interlayer is not limited to one layer, and may be a film comprising multiples layers.

In the above explanation, an IZO film comprising 10 wt % of zinc oxide is used as the first transparent conductive film. However, the addition amount of zinc oxide is not limited to the above figure. An addition amount of zinc oxide ranging from 5 to 15 wt % yields a transparent conductive film, comprising a multilayer film, having a transmittance value not lower than 80% at a wavelength of 550 nm and a specific resistance no greater than 1000 μΩcm. Such a transparent conductive film is preferably used as a transmissive pixel electrode in a transmissive type liquid crystal display device. A transparent conductive film having a specific resistance no greater than 500 μΩcm is yet more preferably used as a transmissive pixel electrode.

The first transparent conductive film is not limited to an IZO film, and may be a film having a chemically stable amorphous phase, as in the case of the IZO film. For instance, the first transparent conductive film may be an IZO-based film comprising additive elements other than indium oxide and zinc oxide. An ISO film, in which samarium oxide (Sm₂O₃) is added to indium oxide (In₂O₃), may also be used as the first transparent conductive film. An addition amount of samarium oxide ranging from 5 to 15 wt % yields a transparent conductive film, comprising a multilayer film, having a transmittance value not lower than 80% at a wavelength of 550 nm and a specific resistance no greater than 1000 μΩcm. Such a transparent conductive film is preferably used as a transmissive pixel electrode in a transmissive type liquid crystal display device. The first transparent conductive film may be an ISO-based film comprising additive elements other than indium oxide and samarium oxide. A zinc oxide (ZnO) film may also be used as the first transparent conductive film. As compared to using ZnO film alone, the transmittance value and the specific resistance of the transparent conductive film comprising a multilayer film is enhanced to a greater extent when using a ZnO-based film comprising ZnO and 1 to 10 wt % of one or more from among aluminum oxide (Al₂O₃), gallium oxide (Ga₂O₃), silicon oxide (SiO₂), titanium oxide (TiO₂), zirconium oxide (ZrO₂) and hafnium oxide (HfO₂). Such oxides have the effect of enhancing optical and electric characteristics, and hence their presence is more preferable. Thus, a film comprising IZO, ISO or ZnO can be used as the first transparent conductive film.

The second transparent conductive film is not limited to an ITO film, and may be a film having a chemically stable crystalline phase, as in the case of the ITO film. The transparent conductive film of the present invention is not limited to a two-layer multilayer film or a three-layer multilayer film. Specifically, the transparent conductive film of the present invention may be a transparent conductive film comprising a multilayer film of two or more layers resulting from layering a film having a chemically stable amorphous phase, as the first transparent conductive film, at the lowermost layer, and a film having a chemically stable crystalline phase, as the second transparent conductive film, at the uppermost layer. The same effect can be achieved by annealing the second transparent conductive film, having been formed in an amorphous state, after etching, to elicit polycrystallinity in the second transparent conductive film.

The transparent conductive film according to the present invention has been illustrated as applied to a transmissive type liquid crystal display device. The invention, however, is not limited thereto. The transparent conductive film of the present invention may be used in display devices that employ display materials other than liquid crystals, for instance organic EL devices, electronic paper or the like. The multilayer transparent conductive film according to the present invention is not limited to display devices, and can be suitably used in other devices. That is, the transparent conductive film according to the present invention can be used in any device where a transparent conductive film is provided straddling step portions such as contact holes or the like.

The above explanation is to describe the embodiments of the present invention and the present invention is not limited to the above embodiments. Moreover, those skilled in the art can change, add and change each component of the above embodiments easily in the scope of the present invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A transparent conductive film having a multilayer film of two or more layers, comprising:
a first transparent conductive film having an amorphous structure; and
a second transparent conductive film, formed over the first transparent conductive film, and having a crystalline structure.

2. The transparent conductive film according to claim 1, wherein the second transparent conductive film is ITO.

3. The transparent conductive film according to claim 1, wherein the first transparent conductive film is a film comprising IZO, ISO or ZnO.

4. The transparent conductive film according to claim 1, further comprising a metallic film, formed between the first transparent conductive film and the second transparent conductive film, and having a lower specific resistance than the first transparent conductive film and the second transparent conductive film.

5. The transparent conductive film according to claim 4, wherein the metallic film is Ag or an alloy having Ag as a main component.

6. The transparent conductive film according to claim 5, wherein the thickness of the metallic film ranges from 5 nm to 20 nm.

7. A display device, comprising the transparent conductive film according to claim 1.

8. A method of manufacturing a transparent conductive film having a multilayer film of two or more layers, comprising the steps of:
forming a first transparent conductive film of stable amorphous structure over a substrate in an amorphous state;
forming a second transparent conductive film of stable crystalline structure over the first transparent conductive film in an amorphous state;
etching the first transparent conductive film and the second transparent conductive film; and
crystallizing the second transparent conductive film after the etching step.

9. The method of manufacturing a transparent conductive film according to claim 8, wherein the second transparent conductive film is formed of ITO.

10. The method of manufacturing a transparent conductive film according to claim 8, wherein the first transparent conductive film is formed by a film comprising IZO, ISO or ZnO.

11. The method of manufacturing a transparent conductive film according to claim 8, further comprising the step of forming a metallic film having a lower specific resistance than the first transparent conductive film and the second transparent conductive film, after the step of forming the first transparent conductive film and before the step of forming the second transparent conductive film.

12. The method of manufacturing a transparent conductive film according to claim 11, wherein the metallic film is formed of Ag or of an alloy having Ag as a main component.

13. The method of manufacturing a transparent conductive film according to claim 12, wherein the thickness of the metallic film ranges from 5 nm to 20 nm.

14. A method of manufacturing a display device provided with a transparent conductive film, comprising the step of:
forming the transparent conductive film using the manufacturing method according to claim 8.
